(19) United States
(12) Patent Application Publication
(10) Pub. No.: US 2025/0218048 A1
(43) Pub. Date: Jul. 3, 2025

(54) SYSTEM AND METHOD FOR ENCODING/DECODING THREE DIMENSIONAL DATA AND APPARATUS FOR THE SAME

(71) Applicant: Electronics and Telecommunications Research Institute, Daejeon (KR)

(72) Inventors: Seong Yong LIM, Daejeon (KR); Da Yun NAM, Daejeon (KR)

(73) Assignee: Electronics and Telecommunications Research Institute, Daejeon (KR)

(21) Appl. No.: 18/791,789

(22) Filed: Aug. 1, 2024

(30) Foreign Application Priority Data
Dec. 27, 2023 (KR) 10-2023-0192510
May 23, 2024 (KR) 10-2024-0067188

(51) Int. Cl. G06T 9/00; G06T 7/11; G06T 7/62; G06T 7/70; G06T 17/00

(52) U.S. Cl. CPC G06T 9/001; G06T 7/11; G06T 7/62; G06T 7/70; G06T 17/00

(57) ABSTRACT

The present invention relates to a system and a method for encoding/decoding 3D data, and an apparatus therefor. A method for encoding 3D data according to one aspect of the present disclosure may include: generating 2D patch data from 2D data; generating patch area separation information for distinguishing the 2D patch data in the 2D data; generating 3D spatial information for the 2D data and/or the 2D patch data; converting the 2D data and/or the 2D patch data into 3D data based on the patch area separation information and the 3D spatial information; and encoding the 3D data.

### CROSS-REFERENCE TO RELATED APPLICATIONS

This application claims the benefit of earlier filing date and right of priority to Korean Application No. 10-2023-0192510, filed on Dec. 27, 2023, No. 10-2024-0067188, filed on May 23, 2024, the contents of which are all hereby incorporated by reference herein in their entirety.

### TECHNICAL FIELD

The present disclosure relates to a method for encoding/decoding three-dimensional data, and more specifically, to a system and a method for encoding/decoding three-dimensional data based on static/dynamic two-dimensional image/video data, and an apparatus therefor.

### BACKGROUND

Currently commercialized 3D (3-dimensional) processing and viewer programs receive 3D data formats such as PLY (polygon), OBJ (object), and gITF (graphics language transmission format) and place and render 3D models in 3D space. However, these programs do not have a function of placing and rendering static or dynamic 2D (2-dimensional) data (images, videos, etc.) in real time in a 3D space, or they are implemented in a limited manner.

For example, when a 3D position and direction of 2D data change on a frame-by-frame basis, it is difficult for existing 3D rendering programs to reflect these changes in real time. Accordingly, there is a limitation that it is difficult to experience a 3D player that can receive a 2D video stream and render and play it in real time.

### SUMMARY

A technical object of the present disclosure is to provide a system and a method for encoding/decoding 3D data based on static/dynamic 2D image/video data, and an apparatus therefor.

In addition, an additional technical object of the present disclosure is to provide a system and a method for converting, formatting, encoding/decoding, and transmitting data to facilitate 3D rendering of 2D image/video data by utilizing an existing 3D media processing tool, and an apparatus therefor.

The technical objects to be achieved by the present disclosure are not limited to the above-described technical objects, and other technical objects which are not described herein will be clearly understood by those skilled in the pertinent art from the following description.

A method for encoding 3D (3-dimensional) data according to one aspect of the present disclosure may include: generating 2D patch data from 2D (2-dimensional) data; generating patch area separation information for distinguishing the 2D patch data in the 2D data; generating 3D spatial information for the 2D data and/or the 2D patch data; converting the 2D data and/or the 2D patch data into 3D data based on the patch area separation information and the 3D spatial information; and encoding the 3D data.

An apparatus for 3D (3-dimensional) data according to an additional aspect of the present disclosure may include: a 2D (2-dimensional) patch data generation unit for generating 2D patch data from 2D data; a patch area separation information generation unit for generating patch area separation information for distinguishing the 2D patch data in the 2D data; a 3D spatial information generation unit for generating 3D spatial information for the 2D data and/or the 2D patch data; a 3D data conversion unit for converting the 2D data and/or the 2D patch data into 3D data based on the patch area separation information and the 3D spatial information; and an encoding unit for encoding the 3D data.

At least one non-transitory computer-readable medium storing at least one instruction according to an additional aspect of the present invention, wherein the at least one instruction executable by at least one processor may control an apparatus for encoding 3D (3-dimensional) data to: generate 2D patch data from 2D (2-dimensional) data; generate patch area separation information for distinguishing the 2D patch data in the 2D data; generate 3D spatial information for the 2D data and/or the 2D patch data; convert the 2D data and/or the 2D patch data into 3D data based on the patch area separation information and the 3D spatial information; and encode the 3D data.

Preferably, the 2D patch data may be generated by separating a specific area and/or an area representing a specific object in the 2D data from the 2D data.

Preferably, the 2D patch data may include at least one of i) information on a location of the specific area and/or the specific object, ii) information on a size of the specific area and/or the specific object, iii) information on a number of the specific area and/or the specific object, iv) information on a type of the specific area and/or the specific object, or v) information on a characteristic of the specific area and/or the specific object.

Preferably, the patch area separation information may be information for distinguishing between a patch area and a non-patch area in the 2D data.

Preferably, the patch area separation information may include information on vertexes and connecting lines of a polygon defining the 2D patch data.

Preferably, the patch area separation information may be stored in a channel in a color space representing the 2D patch data.

Preferably, the 3D spatial information may include at least one of i) 3D position information of the 2D patch data, ii) frontal direction information of the 2D patch data in a 3D space, or iii) movement range information of the 2D patch data in a 3D space.

Preferably, the 3D spatial information may be determined based on i) information on a projected position of a specific area and/or a specific object in a specific direction in the 2D data and ii) projection matching information between the 2D data and a 3D space.

According to an embodiment of the present invention, a system capable of converting, encoding, transmitting, and rendering one or more static/dynamic 2D image/video data into static/dynamic 3D data can be implemented.

In addition, according to an embodiment of the present invention, 3D visualization can be enabled by utilizing a 3D media processing tool based on 2D data input without inputting 3D data.

In addition, according to an embodiment of the present invention, there is an advantage in that flexibility can be increased in processing and handling 2D data (to which 3D spatial information is assigned) by utilizing an existing 3D media processing tool.

In addition, according to an embodiment of the present invention, a simultaneous rendering function of data of different domains can be improved (simultaneous reproduction of 2D images/videos and 3D objects), thereby increasing diversity of visualized multimedia content.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a 3D data encoding/decoding system based on 2D data according to one embodiment of the present invention.

FIG. 2 is a diagram illustrating a 3D data generation unit according to one embodiment of the present invention.

FIG. 3 illustrates a 3D data encoding method according to one embodiment of the present invention.

FIG. 4 is a block diagram of an apparatus for a 3D data encoding method based on 2D data according to one embodiment of the present invention.

### DETAILED DESCRIPTION

Since the present disclosure can make various changes and have various embodiments, specific embodiments will be illustrated in the drawings and described in detail in the detailed description. However, this is not intended to limit the present disclosure to specific embodiments, and should be understood to include all changes, equivalents, and substitutes included in the feature and technical scope of the present disclosure. Similar reference numbers in the drawings refer to identical or similar functions across various aspects. The shapes and sizes of elements in the drawings may be exaggerated for clearer explanation. For a detailed description of the exemplary embodiments described below, refer to the accompanying drawings, which illustrate specific embodiments by way of example. These embodiments are described in sufficient detail to enable those skilled in the art to practice the embodiments. It should be understood that the various embodiments are different from one another but are not necessarily mutually exclusive. For example, specific shapes, structures and characteristics described herein with respect to one embodiment may be implemented in other embodiments without departing from the spirit and scope of the disclosure. Additionally, it should be understood that the position or arrangement of individual components within each disclosed embodiment may be changed without departing from the spirit and scope of the embodiment. Accordingly, the detailed description that follows is not to be intended in a limiting sense, and the scope of the exemplary embodiments is limited only by the appended claims, together with all equivalents to what those claims assert if properly described.

In the present disclosure, terms such as first, second, etc. may be used to describe various components, but the components should not be limited by the terms. The above terms are used only for the purpose of distinguishing one component from another. For example, a first component may be referred to as a second component, and similarly, the second component may be referred to as a first component without departing from the scope of the present disclosure. The term “and/or” includes any of a plurality of related stated items or a combination of a plurality of related stated items.

When a component of the present disclosure is referred to as being “connected” or “accessed” to another component, it may be directly connected or connected to the other component, but other components may exist in between. It must be understood that it may be possible. On the other hand, when it is mentioned that a component is “directly connected” or “directly accessed” to another component, it should be understood that there are no other components in between.

The components appearing in the embodiments of the present disclosure are shown independently to represent different characteristic functions, and do not mean that each component is comprised of separate hardware or one software component. That is, each component is listed and included as a separate component for convenience of explanation, and at least two of each component can be combined to form one component, or one component can be divided into a plurality of components to perform a function, and each of these components can be divided into a plurality of components. Integrated embodiments and separate embodiments of the constituent parts are also included in the scope of the present disclosure as long as they do not deviate from the essence of the present disclosure.

The terms used in this disclosure are only used to describe specific embodiments and are not intended to limit the disclosure. Singular expressions include plural expressions unless the context clearly dictates otherwise. In the present disclosure, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. In other words, the description of “including” a specific configuration in this disclosure does not exclude configurations other than the configuration, and means that additional configurations may be included in the scope of the implementation of the disclosure or the technical feature of the disclosure.

Some of the components of the present disclosure may not be essential components that perform essential functions in the present disclosure, but may simply be optional components to improve performance. The present disclosure can be implemented by including only essential components for implementing the essence of the present disclosure, excluding components used only to improve performance, and a structure that includes only essential components excluding optional components used only to improve performance is also included in the scope of rights of this disclosure.

Hereinafter, embodiments of the present disclosure will be described in detail with reference to the drawings. In describing the embodiments of the present specification, if it is determined that a detailed description of a related known configuration or function may obscure the gist of the present specification, the detailed description will be omitted, and the same reference numerals will be used for the same components in the drawings. Redundant descriptions of the same components are omitted.

The present invention relates to a preprocessing/encoding/transmission/rendering method for receiving static/dynamic 2D image/video data and arranging and reproducing part or all of the 2D image/video data in a 3D space. Specifically, the present invention proposes a method for reproducing/compressing/transmitting 2D data (e.g., 2D image data, 2D video data, etc.) into 3D data (data such as point cloud, mesh, etc. for expressing an image/video (i.e., an object in the image/video) in 3D space coordinates). That is, the present invention is to provide a function for reproducing static or dynamic 2D data in real time or non-real time through a 3D reproduction apparatus.

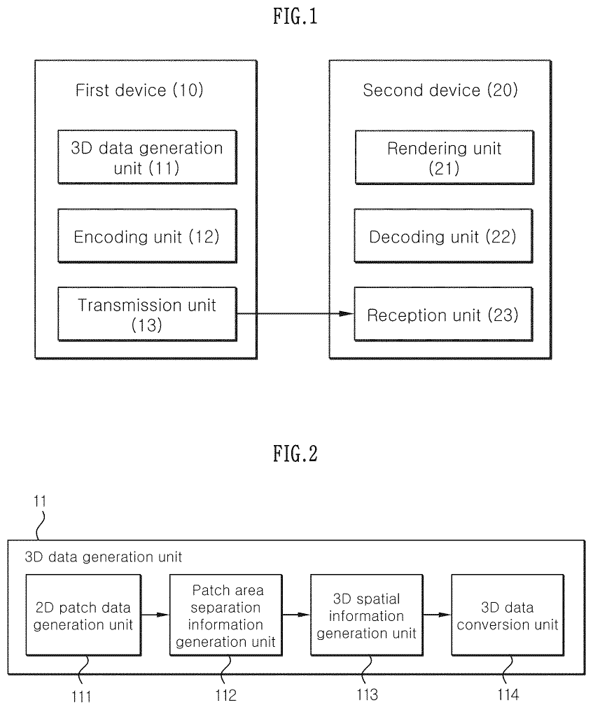

FIG. 1 illustrates a 3D data encoding/decoding system based on 2D data according to one embodiment of the present invention.

Referring to FIG. 1, a 3D data encoding/decoding system based on 2D data may be configured to include a first device (10) (i.e., a content provider, for example, an encoding device) and a second device (20) (i.e., a content player, for example, a decoding device). The first device (10) refers to a device that generates/converts 2D data into 3D data and provides the generated/converted 3D data to the second device (20), and may be configured to include at least one of a 3D data generation unit (11), an encoding unit (12), and a transmission unit (13).

The 3D data generation unit (11) can perform a process of generating 2D patch data of 2D data, a process of assigning 3D information to the 2D patch data, a process of converting 2D data and/or 2D patch data into 3D data, and/or a process of receiving converted 3D data (i.e., 3D raw data) and reconverting and formatting it into a form for transmission and storage.

The encoding unit (12) can perform a process of encoding the converted 3D raw data into a bitstream.

The transmission unit (13) can transmit/provide the encoded bitstream to the second device (20).

The second device (20) means a device that performs 3D rendering based on 3D data provided from the first device (10), and can be configured to include at least one of a rendering unit (21), a decoding unit (22), and a reception unit (23).

The reception unit (23) can receive the bitstream provided from the first device (10).

The decoding unit (22) decodes the bitstream and can obtain information necessary for rendering through it.

The rendering unit (23) can 3D render the decoded 3D data and provide/output a 3D visualized scene to a user.

In FIG. 1, for the convenience of explanation, the 3D data unit/decoding system based on 2D data is illustrated as being divided into the first device (10) and the second device (20), but the present invention is not limited thereto. That is, the system of FIG. 1 can be implemented as one device, and in this case, the first device (10) and the second device (20) can be configured as components within one device.

FIG. 2 is a diagram illustrating a 3D data generation unit according to one embodiment of the present invention.

FIG. 2 illustrates a 3D data generation unit (11) in the first device (10) exemplified in FIG. 1, and may be configured to include a 2D patch data generation unit (111), a patch area separation information generation unit (112), a 3D spatial information generation unit (113), and a 3D data conversion unit (114).

The 2D patch data generation unit (111) may obtain one or more 2D patch data information from 2D data (e.g., 2D image data, 2D video data, etc.). Here, the 2D data may include a general image, a general video, a multi-view image, a multi-view video, a multi-view depth image, a multi-view depth video, etc.

Specifically, the 2D patch data generation unit (111) can derive data on (main) areas and/or objects included in the 2D data into 2D patch data information.

Here, the 2D patch data information can include at least one of information on the location of (main) area(s) and/or object(s), information on the size of (main) area(s) and/or object(s), information on the number of (main) area(s) and/or object(s), information on the type of (main) area(s) and/or object(s), or information on the characteristics of (main) area(s) and/or object(s). Here, the (main) area can be configured based on area(s) including an object(s).

The information on the location and size may indicate the location and/or size of area(s) occupied by the (main) area(s) and/or the object(s) in the 2D data. The information on the type of the (main) area(s) and/or object(s) may include at least one of whether it is a foreground/background and whether the state of the object is dynamic/static. For example, the 2D patch data generation unit (111) can extract one or more (main) areas and objects included in the 2D image data by applying techniques such as object detection, object segmentation, and matting to the 2D image data. In addition, in the case of dynamic 2D image data, the 2D patch data generation unit (111) can extract tracking information of (main) area(s) and object(s) that change over time together. Here, the object tracking information can include movement information of the object(s) over time. For example, by applying an object detection technique or an object segmentation technique, a patch including an object can be extracted from a 2D image. Here, a shape of a patch can be a square shape or a polygonal shape. In addition, a patch can be divided into a valid area and an invalid area. Here, the valid area indicates an area including pixels occupied by an object, and the invalid area indicates an area including pixels not occupied by an object.

Here, each extracted (main) region or (main) object can be designated as one two-dimensional patch data. That is, the patch data can further include not only texture/geometry data for the object, but also region and movement information containing the object. In addition, a different identifier can be assigned to each (main) region or (main) object. Information on the (main) region and/or the object tracking information can be encoded/decoded corresponding to the identifier of each (main) region or (main) object.

In order to generate 2D patch data, the 2D patch data generation unit (111) can separate one or more (main) areas and/or areas representing objects from the 2D data. Here, a shape of the separated area can be a rectangle or a polygon. 2D patch data can be generated from the separated areas. Specifically, data in a form of a rectangular bounding box or a manifold/non-manifold polygon including a (main) area and/or an object on 2D data, can be configured as 2D patch data. That is, one (main) area and/or one object can be defined as one 2D patch data. As a result, the 2D patch data can be data in a rectangular shape or a polygonal shape.

The patch area separation information generation unit (112) can generate ‘patch area separation information’ for each 2D patch data that separates 2D patch data in 2D data.

Here, ‘patch area separation information’ can mean information for separating ‘patch area’ and ‘non-patch area’ in 2D data.

Example 1) The patch area separation information may include information on vertices and connecting lines of a square or manifold/non-manifold polygon defining 2D patch data. For example, the patch area separation information may include information indicating the position of at least one vertex for a polygon of a predetermined shape, the distance between two vertices constituting the polygon, etc. In addition, the patch area separation information may indicate the position and/or size of 2D patch data extracted from 2D image data, or may be for separating valid and non-valid areas within the 2D patch data.

Example 2) The patch area separation information can be stored in one channel within a color space expressing the 2D patch data. For example, if the original 2D patch data is expressed as an RGB (red green blue) image, the color space can be converted from RGB to RGBA (red green blue alpha), and the patch area separation information can be recorded/stored in the A (Alpha) channel value. For example, a value of a pixel corresponding to the patch area in the A image may be set to a first pixel value, and a value of a pixel corresponding to the non-patch area (i.e., a value of a pixel not included in the patch) may be set to a second pixel value. Here, the first pixel value and the second pixel value may be values that are predefined/preconfigured in the encoder/decoder. For example, the first pixel value may be ‘255’ and the second pixel value may be ‘0’. Alternatively, depending on a bit depth, the maximum value or median value that can be expressed by the bit depth may be set as the first pixel value.

Example 3) As the patch area separation information, a mask or occupancy map for each 2D patch data can be generated.

Here, the mask may be for distinguishing valid and invalid areas within the patch. For example, the pixel value corresponding to the valid area within the mask image may be set to a first value, and the pixel value corresponding to the invalid area may be set to a second value. Here, one of the first value and the second value may be 1, and the other may be 0. In addition, the occupancy map is an image of the same size as the 2D image, and the pixel value corresponding to the location occupied by the patch in the occupancy map may be set to a first value, and the pixel value corresponding to the location not occupied by the patch may be set to a second value. Here, the first value and the second value may be values predefined/preconfigured in the decoder/decoder. For example, one of the first value and the second value may be 1 and the other may be 0. Alternatively, the first value in the occupancy map may be set to an index value assigned to the patch. Meanwhile, the occupancy map may be scaled to a smaller size than the 2D image and decoded. In addition, at least one 2D patch data extracted from the same 2D data may be rearranged and merged into one frame. Alternatively, each 2D patch data may be configured as an individual frame. Alternatively, a plurality of 2D patch data may be classified into a plurality of groups, and an individual frame may be generated based on each of the groups.

The 3D spatial information generation unit (113) can assign 3D spatial information to 2D data and/or 2D patch data.

The 3D spatial information that can be assigned to the 2D patch data may include at least one of 3D position information (x, y, z) of the 2D patch data in the 3D space, frontal direction information (θx, θy, θz) of the 2D patch data in the 3D space, or movement range information (x_limit[xmin, xmax], y_limit[ymin, ymax], z_limit[zmin, zmax]) of the 2D patch data in the 3D space.

The 3D spatial information can be determined based on the projection matching information/relative position of the main area and/or object on the 2D data. For example, an area corresponding to a floor on the 2D data can be divided according to a distance, and the 3D spatial information for the object can be generated based on where the position of the object on the floor is located among the divided regions. That is, after matching the area corresponding to the floor of the 2D data to the 3D floor area, the 3D spatial information for each 2D patch data can be generated based on the matching information between the input 2D area and the 3D area. Meanwhile, the ‘projection matching information between 2D data and 3D space’ that matches the floor of the 2D data to the 3D floor area can also be generated by being manually input from an external source (e.g., a user).

In addition, based on the above ‘projection matching information between 2D data and 3D space’, position information and/or direction information on which 2D patch data is arranged in 3D space can be acquired. Specifically, based on the above ‘projection matching information between 2D data and 3D space’, the position and/or direction of 2D patch data for each frame in 3D space can be acquired throughout an entire sequence of static/dynamic 2D data. In addition, based on the ‘projection matching information between 2D data and 3D space’, the movement range of individual 2D patch data (e.g., object) in the 3D space and the entire movement range of the entire 2D patch data in the 3D space for the sequence unit can be acquired. Depending on the movement range and movement direction of the object, direction information of the object for a specific frame can be generated.

The 3D data conversion unit (114) can convert 2D data and/or 2D patch data into 3D data.

Specifically, the 3D data conversion unit (114) can convert the input 2D data and/or 2D patch data within the 2D data into 3D data by utilizing the ‘patch area separation information’ and the ‘3D spatial information’ assigned to the 2D data and/or 2D patch data. For example, when a 2D frame in a 2D data file format such as PNG, JPEG, or YUV is input, the 3D data conversion unit (114) can convert or expand pixels within the area corresponding to the 2D patch data into 3D coordinates, and can generate 3D data in a 3D data file format such as OBJ or PLY. Here, 3D data converted by 2D patch data or by frame can be generated. As a result of converting 2D data in this way, 3D raw data can be generated.

In addition, the 3D data conversion unit (114) can receive converted/generated 3D raw data and reconvert and format it into a form for transmission and storage. For example, the 3D data conversion unit (114) can group the converted 3D raw data according to the display order or encoding order. After that, the 3D data conversion unit (114) can reconvert each group into a form for transmission and storage. For example, the 3D data conversion unit (114) can generate obj data (3D raw data file format) of an entire frame from a 2D video (2D data file format) saved in the mp4 format, group one or more obj data to form an obj data group, and generate a gITF file (Scene Description file format) from the obj data group. For example, from a 2D frame received by receiving SDI (Serial digital interface) or NDI (Network Device Interface) input, the 3D data conversion unit (114) can convert it into obj data in real time, group obj data generated from 30 consecutive frames (about 1 second) to create an obj data group, and generate a gITF file for each obj data group.

Referring back to FIG. 1, the encoding unit (12) in the first device (10) can encode the converted 3D raw data using an existing encoding method. For example, each component (e.g., texture information, geometry information, metadata) of the converted 3D raw data can be encoded using an existing codec, and can be transmitted to the receiver using an existing transmission protocol. For example, if the texture information constituting the 3D raw data is stored as PNG, the geometry information as OBJ, and the metadata information as a TXT file, the encoding unit (12) can encode the PNG sequence using an existing 2D data codec such as HEVC or AV1, and can encode the OBJ sequence using an existing 3D data codec such as Draco.

In addition, the transmission unit (13) in the first device (10) can transmit encoded data to the second device (20) (e.g., a user terminal) by utilizing an existing transmission protocol such as MPEG-DASH. In addition, the rendering unit (21) in the second device (20) can receive the 3D data that is stored (e.g., when the first device (10) and the second device (20) are configured as components in one device) or transmitted (e.g., when the first device (10) and the second device (20) are implemented as separate devices) and perform 3D rendering using a 3D media processing tool, thereby allowing the user to view the 3D visualized scene. Here, the rendering unit (21) can easily render the 3D data generated by referring to the ‘3D spatial information’ and ‘patch area separation information’ allocated to each of the above 2D patch data using the 3D media processing tool. As a result, the effect of visualizing 2D patch data by arranging them in various locations in 3D space can be achieved, and users can easily view 3D scenes containing 2D data through 3D media processing tools.

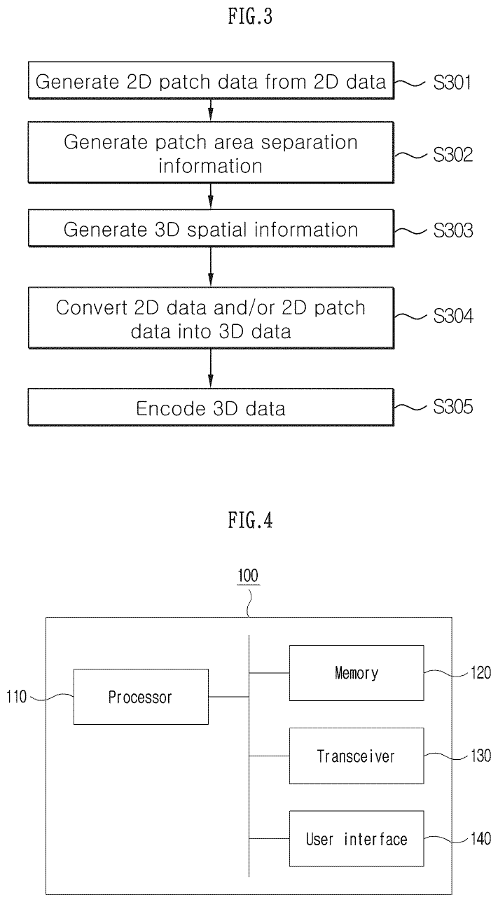

FIG. 3 illustrates a 3D data encoding method according to one embodiment of the present invention.

Referring to FIG. 3, the first device (10) generates 2D patch data from 2D data (S301).

Here, the 2D patch data can be generated by separating specific area(s) and/or area(s) representing specific object(s) within the 2D data from the 2D data.

In addition, the 2D patch data may include at least one of i) information on the location of specific area(s) and/or specific object(s), ii) information on the size of specific area(s) and/or specific object(s), iii) information on the number of specific area(s) and/or specific object(s), iv) information on the type of specific area(s) and/or specific object(s), or v) information on the characteristics of specific area(s) and/or specific object(s).

The first device (10) generates patch area separation information for distinguishing 2D patch data within 2D data (S302).

Here, the patch area separation information may mean information for distinguishing patch area(s) and non-patch area(s) within 2D data.

For example, the patch area separation information may include information on vertexes and connecting lines of polygon(s) defining the 2D patch data. As another example, the patch area separation information may be stored in any one channel within a color space representing the 2D patch data.

The first device (10) generates 3D spatial information for the 2D data and/or the 2D patch data (S303).

Here, the 3D spatial information may include at least one of i) 3D position information of the 2D patch data, ii) frontal direction information of the 2D patch data in the 3D space, or iii) movement range information of the 2D patch data in the 3D space.

For example, the 3D spatial information may be determined based on i) information on projected position(s) of specific area(s) and/or specific object(s) in the 2D data in a specific direction, and ii) projection matching information between the 2D data and the 3D space.

The first device (10) converts the 2D data and/or the 2D patch data into 3D data based on the patch area separation information and the 3D spatial information (S304).

The first device (10) encodes the 3D data (S305).

The first device (10) can transmit encoded 3D data (i.e., bitstream) to the second device (20). The second device (20) can decode the received bitstream and perform 3D rendering based on the 3D data obtained thereby.

FIG. 4 is a block diagram of an apparatus for a 3D data encoding method based on 2D data according to one embodiment of the present invention.

The apparatus (100) for 3D data encoding method based on 2D data may include one or more processors (110), one or more memories (120), one or more transceivers (130), one or more user interfaces (140), etc. The memory (120) may be included in the processor (110) or may be configured separately.

The memory (120) may store instructions that cause the apparatus (100) to perform operations when executed by the processor (110). The transceiver (130) may transmit and/or receive signals, data, etc. that the apparatus (100) exchanges with other entities. The user interface (140) may receive a user's input for the apparatus (100) or provide the output of the apparatus (100) to the user. Among the components of the apparatus (100), components other than the processor (110) and the memory (120) may not be included in some cases, and other components not shown in FIG. 4 may be included in the apparatus (100).

The processor (110) may be configured to cause the apparatus (100) to perform the methods according to various examples of the present disclosure. Although not illustrated in FIG. 4, the processor (110) may be configured as a set of modules that perform each method/function proposed in the present disclosure. The modules may be configured in the form of hardware and/or software.

When the apparatus (100) corresponds to the first device (10) of FIG. 1, the operation is described as follows.

The processor (110) generates 2D patch data from 2D data.

Here, the 2D patch data can be generated by separating area(s) representing specific area(s) and/or specific object(s) in the 2D data from the 2D data.

In addition, the 2D patch data can include at least one of i) information on the location of the specific area(s) and/or the specific object(s), ii) information on the size of the specific area(s) and/or the specific object(s), iii) information on the number of the specific area(s) and/or the specific object(s), iv) information on the type of the specific area(s) and/or the specific object(s), or v) information on the characteristics of the specific area(s) and/or the specific object(s).

The processor (110) generates patch area separation information for separating 2D patch data in the 2D data.

Here, the patch area separation information can mean information for separating patch area(s) and non-patch area(s) in the 2D data.

For example, the patch area separation information may include information on vertexes and connecting lines of a polygon defining the 2D patch data. As another example, the patch area separation information may be stored in any one channel within a color space representing the 2D patch data.

The processor (110) generates 3D spatial information for the 2D data and/or the 2D patch data.

Here, the 3D spatial information may include at least one of i) 3D position information of the 2D patch data, ii) frontal direction information of the 2D patch data in the 3D space, or iii) movement range information of the 2D patch data in the 3D space.

For example, 3D spatial information can be determined based on i) information on specific area(s) in 2D data and/or projected position(s) of specific object(s) in a specific direction, and ii) projection matching information between 2D data and 3D space.

The processor (110) converts 2D data and/or 2D patch data into 3D data based on the patch area separation information and the 3D spatial information.

The processor (110) encodes the 3D data.

The transceiver (130) can transmit the encoded 3D data (i.e., bitstream) to another apparatus.

When the apparatus (100) corresponds to the second apparatus (20) of FIG. 1, the operation is described as follows.

The transceiver (130) can receive encoded 3D data (i.e., bitstream).

The processor (110) can decode the received/input bitstream and perform 3D rendering based on the 3D data obtained through it.

Components described in exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in exemplary embodiments may be implemented in a combination of hardware and software.

The method according to an embodiment of the present disclosure may be implemented as a program that can be executed by a computer, and the computer program may be recorded in various recording media such as magnetic storage media, optical read media, and digital storage media.

The various technologies described in this disclosure may be implemented as digital electronic circuits or computer hardware, firmware, software, or a combination thereof. The above technologies may be implemented as a computer program product, that is, a computer program tangibly embodied in an information medium (e.g., a machine-readable storage device (e.g., a computer-readable medium) or a data processing device) or a computer program implemented as signals processed by or propagated by a data processing device to cause the operation of the data processing device (e.g., programmable processor, computer, or multiple computers).

Computer program(s) may be written in any form of programming language, including compiled or interpreted languages and may be distributed as a stand-alone program or in any form, including modules, components, subroutines, or other units suitable for use in a computing environment. A computer program may be executed by a single computer or by multiple computers distributed at one site or multiple sites and interconnected by a communications network.

Examples of processors suitable for executing computer programs include general-purpose and special-purpose microprocessors, and one or more processors in digital computers. Typically, a processor receives instructions and data from read-only memory, random access memory, or both. Components of a computer may include at least one processor for executing instructions and one or more memory devices for storing instructions and data. Additionally, the computer may include one or more mass storage devices for data storage, such as magnetic, magneto-optical disks, or optical disks, or may be connected to the mass storage devices to receive and/or transmit data. Examples of information media suitable for implementing computer program instructions and data include optical media such as semiconductor memory devices (e.g., magnetic media such as hard disks, floppy disks, and magnetic tapes), compact disk read-only memory (CD-ROM), digital video disk (DVD), etc., magneto-optical media such as floptical disks, and read only memory (ROM), random access memory (RAM), flash memory, erasable programmable ROM (EPROM), electrically erasable programmable ROM (EEPROM), and other known computer-readable media. Processors and memories can be supplemented or integrated by special-purpose logic circuits.

A processor may run an operating system (OS) and one or more software applications that run on the OS. The processor device may also access, store, manipulate, process and generate data in response to software execution. For simplicity, the processor device is described in the singular, but those skilled in the art will understand that the processor device may include a plurality of processing elements and/or various types of processing elements. For example, a processor device may include a plurality of processors or a processor and a controller. Additionally, different processing structures, such as parallel processors, may be configured. Additionally, computer-readable media refers to all media that a computer can access, and may include both computer storage media and transmission media.

Although this disclosure includes detailed descriptions of various detailed implementation examples, the details should not be construed as limiting the invention or scope of the claims proposed in this disclosure, but rather illustrating features of specific exemplary embodiments.

Features individually described in exemplary embodiments in this disclosure may be implemented by a single exemplary embodiment. Conversely, various features described in this disclosure with respect to a single exemplary embodiment may be implemented by a combination or appropriate sub-combination of a plurality of exemplary embodiments. Furthermore, in the present disclosure, the features may operate by a specific combination, and the combination may initially be described as claimed, however, in some cases, one or more features may be excluded from the claimed combination, or claimed combinations may be modified in the form of sub-combinations or modifications of sub-combinations.

Similarly, even if operations are depicted in a specific order in the drawings, it should not be understood that execution of the operations in a specific order or sequence is necessary, or that performance of all operations is required to obtain a desired result. In certain cases, multitasking and parallel processing can be useful. Additionally, it should not be understood that the various device components in all exemplary embodiments are necessarily separate, and the above-described program components and devices may be packaged in a single software product or multiple software products.

The exemplary embodiments disclosed herein are illustrative only and are not intended to limit the scope of the disclosure. Those skilled in the art will recognize that various modifications may be made to the exemplary embodiments without departing from the scope of the claims and their equivalents.

Accordingly, this disclosure is intended to include all other substitutions, modifications and changes that fall within the scope of the following claims.

What is claimed is:

1. A method for encoding 3D (3-dimensional) data, the method comprising:
generating 2D patch data from 2D (2-dimensional) data;
generating patch area separation information for distinguishing the 2D patch data in the 2D data;
generating 3D spatial information for the 2D data and/or the 2D patch data;
converting the 2D data and/or the 2D patch data into 3D data based on the patch area separation information and the 3D spatial information; and
encoding the 3D data.

2. The method of claim 1, wherein the 2D patch data is generated by separating a specific area and/or an area representing a specific object in the 2D data from the 2D data.

3. The method of claim 1, wherein the 2D patch data includes at least one of i) information on a location of the specific area and/or the specific object, ii) information on a size of the specific area and/or the specific object, iii) information on a number of the specific area and/or the specific object, iv) information on a type of the specific area and/or the specific object, or v) information on a characteristic of the specific area and/or the specific object.

4. The method of claim 1, wherein the patch area separation information is information for distinguishing between a patch area and a non-patch area in the 2D data.

5. The method of claim 4, wherein the patch area separation information includes information on vertexes and connecting lines of a polygon defining the 2D patch data.

6. The method of claim 4, wherein the patch area separation information is stored in a channel in a color space representing the 2D patch data.

7. The method of claim 1, wherein the 3D spatial information includes at least one of i) 3D position information of the 2D patch data, ii) frontal direction information of the 2D patch data in a 3D space, or iii) movement range information of the 2D patch data in a 3D space.

8. The method of claim 1, wherein the 3D spatial information is determined based on i) information on a projected position of a specific area and/or a specific object in a specific direction in the 2D data and ii) projection matching information between the 2D data and a 3D space.

9. An apparatus for 3D (3-dimensional) data, the apparatus comprising:
a 2D (2-dimensional) patch data generation unit for generating 2D patch data from 2D data;
a patch area separation information generation unit for generating patch area separation information for distinguishing the 2D patch data in the 2D data;
a 3D spatial information generation unit for generating 3D spatial information for the 2D data and/or the 2D patch data;
a 3D data conversion unit for converting the 2D data and/or the 2D patch data into 3D data based on the patch area separation information and the 3D spatial information; and
an encoding unit for encoding the 3D data.

10. The apparatus of claim 9, wherein the 2D patch data is generated by separating a specific area and/or an area representing a specific object in the 2D data from the 2D data.

11. The apparatus of claim 9, wherein the 2D patch data includes at least one of i) information on a location of the specific area and/or the specific object, ii) information on a size of the specific area and/or the specific object, iii) information on a number of the specific area and/or the specific object, iv) information on a type of the specific area and/or the specific object, or v) information on a characteristic of the specific area and/or the specific object.

12. The apparatus of claim 9, wherein the patch area separation information is information for distinguishing between a patch area and a non-patch area in the 2D data.

13. The apparatus of claim 12, wherein the patch area separation information includes information on vertexes and connecting lines of a polygon defining the 2D patch data.

14. The apparatus of claim 12, wherein the patch area separation information is stored in a channel in a color space representing the 2D patch data.

15. The apparatus of claim 9, wherein the 3D spatial information includes at least one of i) 3D position information of the 2D patch data, ii) frontal direction information of the 2D patch data in a 3D space, or iii) movement range information of the 2D patch data in a 3D space.

16. The apparatus of claim 9, wherein the 3D spatial information is determined based on i) information on a projected position of a specific area and/or a specific object in a specific direction in the 2D data and ii) projection matching information between the 2D data and a 3D space.

17. At least one non-transitory computer-readable medium storing at least one instruction, wherein the at least one instruction executable by at least one processor controls an apparatus for encoding 3D (3-dimensional) data to:
generate 2D patch data from 2D (2-dimensional) data;
generate patch area separation information for distinguishing the 2D patch data in the 2D data;
generate 3D spatial information for the 2D data and/or the 2D patch data;
convert the 2D data and/or the 2D patch data into 3D data based on the patch area separation information and the 3D spatial information; and
encode the 3D data.
